(19) United States
(12) Patent Application Publication
(10) Pub. No.: US 2005/0231744 A1
(43) Pub. Date: Oct. 20, 2005

(54) Method and device to offset stack pages of successive print or copy jobs

(76) Inventor: Christian Riedl, Kirchseeon (DE)

Correspondence Address: SCHIFF HARDIN, LLP;PATENT DEPARTMENT, 6600 SEARS TOWER, CHICAGO, IL, 60606-6473, US

(21) Appl. No.: 10/824,863

(22) Filed: Apr. 15, 2004

(51) Int. Cl. G06K 13/00

(52) U.S. Cl. 358/1.12

(57) ABSTRACT

A method and a device to offset stack pages of successive print or copy jobs that are supplied to a page output unit as a page stream. The pages of the successive second job are offset stacked over the pages of the preceding first job and are spatially displaced with regard to the pages of the first job. After the offset stacking of the first job, the uppermost page of the first page stack is mechanically fixed to the first page stack.

### BACKGROUND OF THE INVENTION

1. Field of the Invention

The present invention relates generally to a method and a device to offset stack pages of successive print or copyjobs in a printer or copier.

2. Description of the Related Art

From U.S. Pat. No. 6,212,357, a print device is known in which pages of recording media are selectively drawn from a plurality of paper reservoirs and printed. On the output side, the printed pages are stored in a plurality of output receptacle bins. In such print devices, it is typical that the pages to be printed are grouped per job, for example that a job comprises a document that is printed on one or more pages, or a plurality of documents each with one or more page.

The greater the print capacity of a print device for page-shaped recording media, the more value is placed on offset stacking the printed recording media cleanly and perfectly in the output bin. Therefore a number of measures are known that have the goal of aligning the recording media to be stored with regard to an edge or wall of the output bin using their transport speed and their own weight.

In special application cases, in high-capacity print devices (for example electro-photographic printers in continuous operation) a plurality of print jobs are processed in succession. For the organization of the print operation, a significant feature of a print job is that the quantity of the printed recording media respectively associated with a single print job must be further dealt with. This means that recording media associated with various print jobs are to be separated from one another at the output station of the print device in order to separately bundle, pack or handle them in another manner.

Modern high-capacity printers output print goods in such a quantity and speed that it can appear unreasonable for the operating personnel to undertake the task of completely separating the stored stack of the printed recording media into the individual print jobs without additional auxiliary means.

Given a relatively low print capacity, one could, without great loss of capacity, respectively interrupt the print process after completion of a print job, remove the stack of recording media associated with this print job from the output bin and afterwards restart the print process. The relatively comfortably controls for modern print devices allow such an automatic stop without anything further, however such a job-based print output in a start/stop operation would be connected with an ever greater productivity loss given growing nominal capacity of the print device.

A storage device to offset stack page-shaped recording media in an output bin of a print device is known from European patent document EP-B1-404786. The recording media can thereby be offset stacked in the output bin displaced to the side per job. The output bin comprises side walls whose distance from one another is greater than the stack width of the recording media. Furthermore, alignment units are provided that are respectively arranged adjacent to the front corners of the storage bin and can be alternately activated. They respectively comprise an actuated paddlewheel whose paddles collect an incoming recording media and transport these transverse to a main transport direction of the recording media in the direction of the associated side wall. The recording media can therewith by offset stacked displaced to the side per job.

From the International PCT published application WO-A2-00/24659, various alignment devices based on paddle wheels are known that can be viewed as further developments of the device known from European patent document EP-B1-404768.

### SUMMARY OF THE INVENTION

The present invention provides a method and apparatus to improve the displaced output of page-shaped recording media. Pages of successive print jobs that are offset stacked are supplied to a page output unit as a page stream, whereby the pages of the subsequent second print job are offset stacked and in particular spatially displaced to the side with regard to these, to achieve an arrangement of the associated pages of a print job that lie optimally in good register atop one another.

According to the method and apparatus, to offset stack pages of successive print or copy jobs that are supplied to a page output unit as a page stream, the pages of the successive second job are offset stacked over the pages of the preceding first job and are spatially displaced or offset with regard to these, and after the offset stacking of the first job the uppermost page of the first page stack thereby created is mechanically fixed to the first page stack.

### BRIEF DESCRIPTION OF THE DRAWINGS

Further advantages and effects of the invention can be learned from the following description of an exemplary embodiment.

FIG. 1 is a top plan view of a storage bin in a print device according to the invention;

FIG. 2 is a perspective view of details of an alignment unit of FIG. 1;

FIG. 3 is an enlarged side view of a mechanical fixing device;

FIG. 4 is a longitudinal section of the fixing device of FIG. 3; and

FIG. 5 is a functional block diagram of a pneumatic system of the invention.

### DETAILED DESCRIPTION OF THE PREFERRED EMBODIMENTS

The invention provides offset stacking of pages of successive print jobs that are supplied to a page output unit as a page stream, in which the pages of the first job are output displaced with regard to the pages of the successive job, and with which an optimally precise separation of the two page stacks thereby generated is possible. In somewhat more detail, the invention concerns the offset stacking of pages that are supplied as a page stream to a page output unit, in particular in a printing device. In further detail, the invention concerns a page stream in which the pages of a subsequent second print job are offset stacked over the pages of a preceding first print job and are spatially offset with regard to these.

To offset stack pages of successive print or copy jobs that are supplied to a page output unit as a page stream, whereby the pages of the successive second print job are offset stacked over the pages of the preceding first print job and are spatially displaced with regard to the pages of the previous print job, and after the offset stacking of the first job the uppermost page of the first page stack thereby generated is mechanically fixed to the first page stack.

The present inventor has recognized that, given offset stacking of pages of successive print or, respectively, copyjobs, the separation of the pages of the first job from the pages of the second job can be improved, in that the registration of the pages of a job is improved. Furthermore, he has recognized that the registration of the pages of the first job can be improved when, after the offset stacking of the first job, the uppermost page of the first page stack is mechanically fixed to the page stack.

According to a preferred exemplary embodiment of the invention, the fixing ensues in a region of the uppermost page that, due to the spatial displacement, is not covered by pages of the second job. The fixing can in particular ensue via pressure, for example via mechanical pressure or via positive or negative pressure of a gas or gas mixture, for example air. The positive or negative pressure can in particular be generated by a compressor, whereby it is advantageously possible to additionally generate the negative or, respectively, positive pressure generated by the compressor to separate page-shaped recording media from a stack, for example in a pneumatic individual page feeder of a print or copy device.

The strength of the positive or, respectively, negative pressure can in particular be adjusted depending on the weight of the pages.

The offset stacking in particular ensues in an output device of a print or copy device for documents.

According to a development of the invention, all pages are offset stacked in a page acceptance region that is bordered by two stoppers, fashioned at right angles, that respectively comprise a side wall arranged at a right angle thereto, whereby the lateral displacement ensues along the common axis. For the offset stacking of the first pages of the first job, a paddlewheel arranged in the region of the first stop can thereby be used that advances the first pages with their corners at the right angle of the first stopper; for the offset stacking of the second pages of the second job, a second paddlewheel in the region of the second stopper is used that advances the second pages with their corners at the right angle of the second stopper; and whereby the mechanical fixing respectively ensues in the region of a stopper. For a format reorientation of the pages, it can thereby furthermore be provided to shift along the axle one of the two paddle wheels and a device to mechanically fix the pages. It can thereby be advantageous to rigidly mechanically connect the paddle wheel and the device for mechanical fixing.

When pages of a third job follow the pages of the second job, it can be advantageous after the offset stacking of the second job to mechanically fix the uppermost page of the second page stack to the second page stack, while the pages of the third job are offset stacked without displacement with regard to the first page stack. It can thereby be provided that the fixing of the uppermost page of the second page stack ensues in a region of the uppermost page that, due to the spatial displacement, is not covered by pages of the third job.

According to a further advantageous embodiment of the invention, the fixing of the uppermost page of the preceding job after the offset stacking of a plurality of pages of the subsequently job is cancelled. The job can in particular be a print job and/or a copy job.

The invention can in particular be combined with method steps, devices or means that are known from the publications cited in the introduction of this specification. These are for this purpose again included in the present specification at this point via reference.

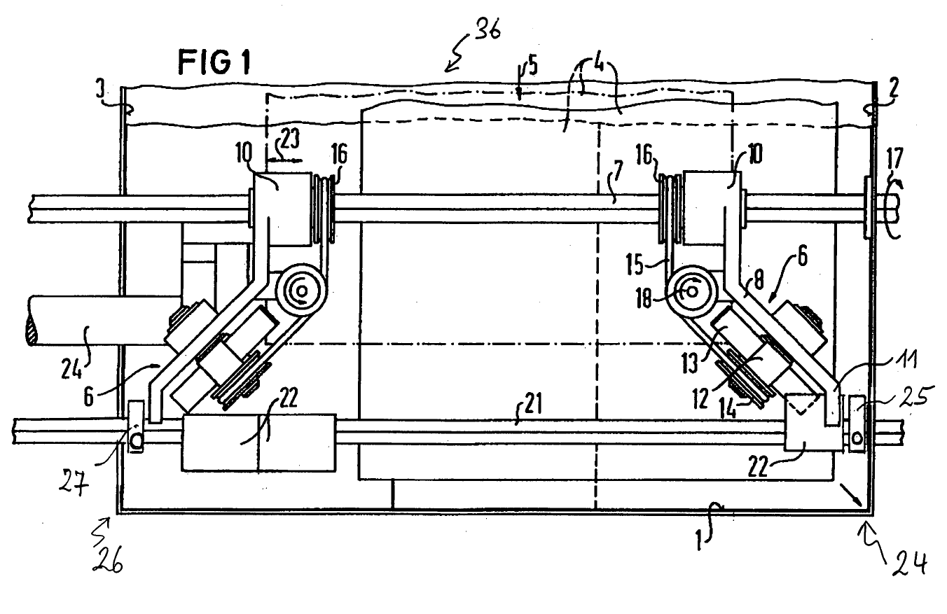

Referring to the drawings, in FIG. 1, an output bin of a print device 36 is schematic represented by a front wall 1 as well as by two side walls 2 or, respectively, 3. The print device can also be a component of a copier system in which copy originals are optically scanned and reproduced on page-shaped recording media.

Page-shaped recording media 4 (i.e. pages of recording media) arrive in the output bin mentioned above with a transport direction characterized by an arrow 5 and are stored flush with the front wall 1. In the corners of the output bin formed by the front wall 1 and one of the side walls 2 or, respectively, 3, two alignment units 6 are arranged adjacent to the front side that, given identical design, are arranged substantially mirror-symmetric to one another with regard to the transport direction 5. It is therefore sufficient to specify one of the two alignment units 6 in detail.

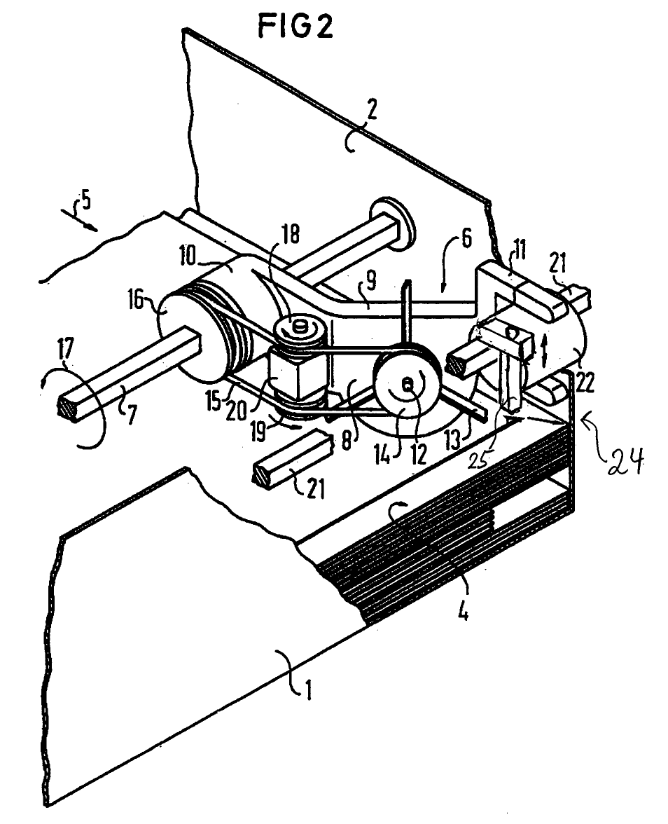

For this, one of the corners of the output bin that is formed by the front wall 1 and the side wall 2 is shown in FIG. 2 in three-dimensional representation. A stack of page-shaped recording media 4 that are already stored are schematically shown. An axle 7 embedded in the side wall 2 is arranged over and parallel to the surface of this stack of printed recording media 4.

The alignment unit 6 shown in FIG. 2 is substantially comprised of an angled bearing body 8 with a middle part 9, with a bearing eye 10 attached curved to one side of the middle part 9, and with a U-shaped fork or bracket 11 likewise curved in the direction of the front wall 1 and attached on the other end of the middle part 9. The bearing body 8 is positioned with the bearing eye 10, as is to be explained in detail later, such that it can be rotated on the axle 7. An impeller 12 is laterally attached to the middle part 9 such that it can be moved. This impeller 12 comprises a plurality of vanes 13 that are regularly arranged on its circumference and are extending radially outwards. These vanes 13 are fashioned elastically and form the alignment elements for the recording media 4.

It is indicated in FIG. 2 that the impeller 12 revolves counter-clockwise; it is connected with a drive roller 14 that attaches externally to the impeller. A drive belt 15 that, for its part, is driven by a drive roller 16 is friction-connected with the drive roller 14, the drive roller 16 being slid on the axle 7 directly adjacent to the bearing eye 10 of the bearing body 8. This axle 7 not only forms the bearing element for the entire alignment unit 6, but also simultaneously forms a continuously revolving drive shaft, as indicated by an arrow 17. It preferably exhibits a square-edged or angular profile. The drive roller 16 possesses as an intake a recess with a corresponding counter-profile and is therefore coupled with this drive shaft 7 such that it can be rotated. However, the bearing housing 10 of the bearing body 8 (details of which are shown in FIG. 1) is positioned on the drive shaft 7 such that it can be rotated, such that it is not entrained by the rotating shaft.

The drive (which runs in the same direction with the transport direction 5 of the recording media) of the drive shaft 7 or, respectively, of the drive roller 16 is converted in the impeller 12 into a transverse direction or motion for the recording media 4 that points in the direction of the corner of the output bin, and thus essentially in a direction lying at 45° transverse to the transport direction 5. In order to provide such transverse motion with a belt drive, two deflection rollers 18 and 19 are provided. These are mounted for rotational movement on the on the top or, respectively, bottom of a bearing block 20 that is attached laterally to the bearing body 8 between its middle part 9 and the bearing housing 10.

The belt drive is formed from the pressure roller 16, the drive roller 14 and the drive belt 15. The impeller 12 is driven counterclockwise such that the rotation movement of its vanes 13 point in the direction of the corner formed by the front wall 1 and the one side wall 2 of the output bin. The vanes 13 serve as alignment elements for the recording media 4 to be offset stacked; in the active state of the alignment unit 6, the vanes come into friction contact with the incoming recording medium 4 and pull the acquired surface of the recording medium in the direction of the associated corner of the output bin, such that it aligns there.

This effect on the recording media 4 may now only ensue in the activated state of the alignment unit 6. In order to enable this, the alignment unit is arranged such that it can be pivoted on the drive shaft 7, such that, in the swiveled-out position of the alignment unit 6, the vanes 13 of the impeller 12 do not come into contact with recording media 4 coming into the storage bin.

In order to effect this pivot movement of the alignment unit 6, a further shaft that is fashioned as a control shaft 21 is provided parallel to the drive shaft 7. This control shaft 21 lies approximately concentric to the fork 11 of the bearing body 8 of the alignment units 6 and comprises in the region of this fork eccentric rollers 22, rigidly coupled with it, that are arranged on the control shaft 21 working in opposite directions with regard to the two alignment units 6. This means that the bearing body 8 of both alignment units 6 executes seesaw motions in opposite directions upon rotation of the control shaft 21.

Thus, if the alignment unit 6 shown on the left in FIG. 1 at an angular position of the control shaft 21 is in the operating position, meaning that this alignment unit is in friction contact with the incoming recording media 4, then the other alignment unit 6 (shown on the right of the figure) is out of contact with the recording media 4. If the control shaft 21 is rotated 180°, the function of the alignment units 6 changes. The previously activated alignment unit 6 then rotates freely while the other, previously inactive alignment unit then slides the recording media 4 into the opposite corner of the output bin.

FIG. 1 indicates that a plurality of eccentric rollers 22 are associated with the alignment unit 6 shown on the left in FIG. 1. The reason for these measures is to be sought in that the output bin formed from the front wall 1 an the side walls 2 or, respectively, 3 should be adjustable to different formats of recording media 4 to be offset stacked. With regard to this, it is assumed that the second side wall 3 is fashioned such that its distance from the opposite side wall 2 can be shifted. In order to now ensure a precise alignment of the recording media 4 in the corner of the output bin formed by the front wall 1 and this shiftable side wall 3 the associated alignment unit 6—shown on the left in FIG. 1—must also be capable of being laterally shifted, as is schematically indicated by a further arrow 23.

The reason for the profile of the drive shaft 7 is thus also clear. With the axial shifting of the alignment unit 6 arranged on the left in FIG. 1, at the same time its drive roller 16 of the belt drive is shifted without interfering with the functional coupling with the drive shaft. It is indicated in FIG. 1 that coupled to the shiftable alignment unit 6 is a connecting push rod 24 with which, upon setting the adjustable side wall 3 to another format of the recording media 4, the alignment unit shown on the left in FIG. 1 can also correspondingly be axially shifted.

In the region of the cover 24 that is formed by the front wall 1 and the side wall 2, a paper hold-down pad 25 is provided with which page-shaped recording media 4 that were advanced into the corner 24 with the impeller 12 can be spatially fixed. The hold-down 25 is thereby mechanically coupled by means of the control shaft 21 with the bearing body 8 perpendicular to the plane in which the recording media 4 comes to lie. The hold-down 25 is in an upper position when the alignment unit 6 is in the operating position, meaning the vanes 13 of the paddlewheel 12 are in friction-contact with the incoming recording media. In this upper position, the hold-down 25 does not contact the incoming recording media. In contrast to this, when the alignment unit 6 is out of contact with the recording media and the paddlewheel is raised, the hold-down 25 is then in a lower operating position in which it contacts the uppermost recording media 4 in the corner 24 and preferably presses on the media with an elastic force. The uppermost recording media 4 and also the recording media lying beneath it is thereby fixed in the region of the corner 24. In particular, the pages which are seated by the alignment unit 6 in the corner 24 are prevented from being moved out from the corner 24 by the hold-down. This prevents offset stacking and misalignment of the pages from the aligned position and thereby prevents an imprecise offset of successive jobs.

After a new job offset, via rotation of the control shaft 21 the alignment unit seated on the side wall 3 is raised, a page hold-down 27 lying in the region of the corner 26 is lowered onto the uppermost recording media 4, the alignment unit 6 lying on the side wall 2 is lowered, and the page hold down 25 seated in the corner 24 is raised. After this, the next job can be processed and its pages can be offset stacked in the corner 24. The page hold-downs 25 and 27 and alignment units are connected or, respectively, mechanically coupled with the shaft 21 such that, given a rotation movement of the shaft 21, the associated hold-downs and alignment units of one side respectively move in opposite directions, in particular upwards or, respectively, downwards.

The page hold-down 27, together with the alignment unit 6 arranged on the side wall 3, can be laterally shifted along the direction 23 on the shaft 21 in order to adapt the arrangement of alignment unit 6 and page hold-down 17 to various paper formats.

In addition to or instead of an elastic force, it can be provided that the page hold-downs 25 and 27 are equipped with a negative pressure system to fix the uppermost recording media with the page the page hold-downs 25 and 27.

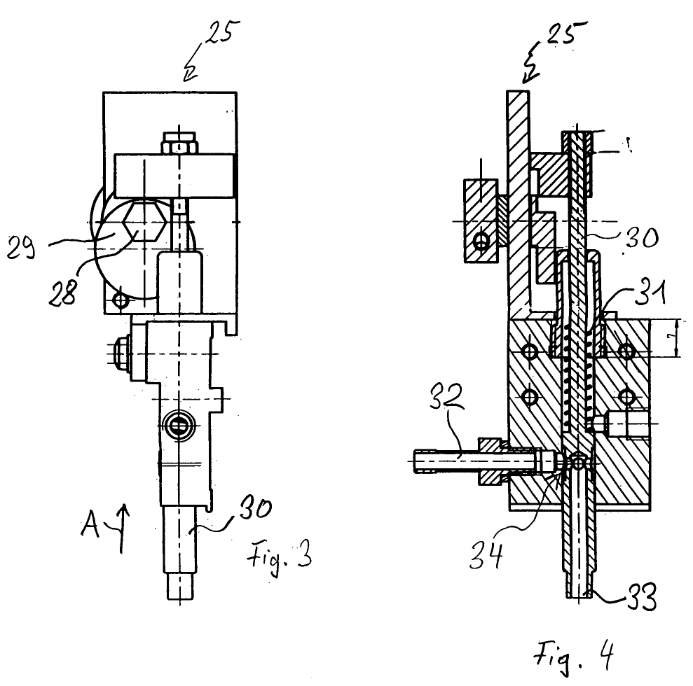

FIG. 3 shows the page hold-down 25 and the mechanical components moving in the vertical direction. The hold-down 25 is slid over a shaft opening 28 of an eccentric disc 29 on the control shaft 21. In FIG. 3, the hold-down 25 is shown in its lower position. When the control shaft 21 is rotated and the eccentric disc 29 is rotated by 180°, the fixing sleeve 30 is shifted upwards in direction A.

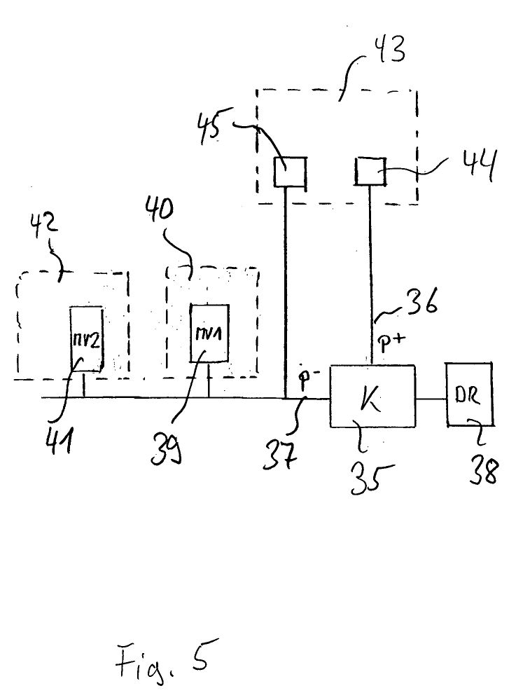

FIG. 4 shows a longitudinal section through the hold-down 25 of FIG. 3. It can be seen therein that the fixing sleeve 30 is pre-stressed with a spring 31 via which, in the lowered state, a pressure can be exerted on the adjacent uppermost recording medium sheet. The hold-down 25 additionally comprises a pressure port or connection 32 with which the hold-down 25 can be charged with negative air pressure, such that a negative pressure is also set up at the lower opening 33 of the fixing sleeve 30. With the negative air pressure, it is possible to draw to the lower opening (and therewith to fix) the surface of the uppermost recording medium sheet. Given small job runs of down to one page per job, it is thereby also possible to securely affix the uppermost (last) page of the job, even when the page lies on an unstable base. Such an unstable base is in particular present when the job that is laterally offset beforehand is a significant number of pages and the job with the current page to be fixed comprises only one or a few pages.

Whether a negative pressure is applied to the sleeve end 33 is automatically controlled via the vertical motion A of the sleeve 30. The interface between the negative pressure connection 32 and the lower part of the sleeve 30 thereby acts as a valve in the region 34. The valve setting (whether the valve is open or closed) is thereby directly determined via the setting of the page hold down (in an up or down position), and thereby via the setting of the control shaft 21. The positions of the alignment units, the page hold downs and the valves can thus be simultaneously or, respectively, directly controlled with the control shaft 21.

A pneumatic system in an electro-photographic printer system is shown in FIG. 5. For this, a compressor 35 generates positive pressure on a pressure side 36 and negative pressure on a negative pressure side 37. The pressure can be regulated via a throttle or choke 38. The pressure system is closed via a magnetic valve 39 at a first output bin 40 (as is shown in FIGS. 1 and 2) and via a magnetic valve 41 at a structurally identical second output bin 42. The magnetic valves 39 and 41 can be controlled, by mechanical force-coupling, with a paper path gate that deflects the page-shaped recording media into the corresponding output bins. The control effort is thereby minimized. Furthermore, the print device comprises a page feeder 43 for the recording media to be printed, and also includes the positive pressure valves 44 and negative pressure valves 45.

The negative pressure for the storage bins (which comprise, for example, a plurality of hold downs according to FIGS. 1 through 4) is, in the lower setting of the page hold down, selected to be great enough that the uppermost page is securely held, and yet low enough that the page is not lifted upon raising of the hold down. The negative pressure is in particular adjusted to be dependent on the paper weight. In order to prevent lifting of the page upon raising of the hold down, the negative pressure source can in particular be closed off, and a connection to the environment can be produced, whereby the negative pressure at the contact point between hold down and the page quickly dissipates, and the hold down can thereby easily be separated from the page.

The invention has been disclosed using exemplary embodiments. It is thereby clear that the average man skilled in the art can appreciate that further developments and modifications of the invention are possible. It is in particular advantageous in the disclosed arrangements that a mechanical coupling between the raising/lowering motions of the alignment units with the page hold downs ensues such that, respectively, the necessary page hold down is lowered when the alignment unit corresponding thereto is raised. Furthermore, the coupling between negative pressure units at different device aggregates of a printer is advantageous.

Although other modifications and changes may be suggested by those skilled in the art, it is the intention of the inventors to embody within the patent warranted hereon all changes and modifications as reasonably and properly come within the scope of their contribution to the art.

1. A method to offset stack pages of successive print or copyjobs that are supplied to a page output unit as a page stream, comprising the steps of:
offset stacking the pages of a successive second job over the pages of a preceding first job;
spatially offsetting the pages of the successive second job with respect to the pages of the preceding first job; and
mechanically fixing an uppermost page to a first page stack after offset stacking of the first job.

2. A method according to claim 1, said step of fixing ensues in a region of the uppermost page that is not covered by pages of the second job due to the spatial displacement of the pages of the second job relative to the first job.

3. A method according to claim 1, wherein said step of fixing uses pressure on the uppermost page.

4. A method according to claim 3, wherein the pressure is mechanically exerted.

5. A method according to claim 3, wherein the pressure is exerted as one of a positive pressure and a negative pressure of a gas or gas mixture.

6. A method according to claim 5, wherein the gas mixture is air.

7. A method according to claim 5, further comprising the step of:
generating said one of positive and negative pressure for the pressure on the uppermost page by a compressor that is also used to generate one of negative and positive pressure to separate page-shaped recording media from a stack.

8. A method according to claim 5, further comprising the step of:
adjusting a strength of said one of positive and negative pressure dependent on a weight of the pages.

9. A method according to claim 1, wherein said offset stacking ensues in an output device of a printer or copy device.

10. A method according to claim 1, wherein said step of offset stacking is carried out in a page acceptance region that is bordered by two stoppers disposed at right angles to one another, said two stoppers including a front wall lying on a common axis and a side wall arranged at a right angle thereto, and further comprising the steps of:
laterally displacing the pages along a common axis;
using a first paddlewheel for said offset stacking of the first pages of the first job, said first paddlewheel being provided in a region of the first stopper to advance the first pages with their corners into the right angle of the first stopper;
using a second paddlewheel for the offset stacking of the second pages of the second job, said second paddlewheel being provided in a region of the second stopper to advance the second pages with their corners into the right angle of the second stopper; and
performing said step of mechanical fixing in the region of a stopper.

11. A method according to claim 10, further comprising the steps of:
shifting one of said first and second paddlewheels and a device to mechanically fix the pages along an axle for a format change-over of the pages.

12. A method according to claim 11, wherein said paddlewheels and said device to mechanically fix the pages are mechanically and rigidly connected with one another.

13. A method according to claim 1, further comprising the step of:
mechanically fixing an uppermost page of a second page stack to the second page stack after offset stacking of the second job and while a subsequently third job is offset stacked without displacement with regard to the first page stack.

14. A method according to claim 13, wherein said step of mechanically fixing of the uppermost page of the second page stack ensues in a region of the uppermost page that is not covered by pages of the third job due to spatial displacement of said second page stack from said third job.

15. A method according to claim 1, further comprising the step of:
raising a fixing device for an uppermost page of a preceding job again after offset stacking of a plurality of pages of a further subsequent job.

16. A method according to claim 1, wherein the job is a print job.

17. A method according to claim 1, wherein the job is a copy job.

18. A method according to claim 1, wherein said fixing of the uppermost page performed with negative pressure, and a device to fix the uppermost page includes a valve that is opened and closed under control of a vertical position of the device for fixing.

19. A method according to claim 18, further comprising the step of:
controlling the vertical position of the device to fix via a control shaft with the vertical position of a paddlewheel to offset stack the print or copy job.

20. A device to offset stack pages of successive print or copyjobs that are supplied to a page output unit as a page stream, comprising:
a page offset stacking apparatus mounted and operable to offset stack the pages of a successive second job over pages of a preceding first job so that said pages of said second job and said first job are spatially offset with respect to one another; and
a fixing device with which an uppermost page of the first page stack is mechanically fixed to the first page stack.

21. A device according to claim 20, wherein said fixing device is disposed in a region of the uppermost page that is not covered by pages of the second job due to the spatial displacement.

22. A device according to claim 20, wherein said fixing device is operable to exert a pressure on the uppermost page.

23. A device according to claim 22, wherein the pressure is mechanically exerted.

24. A device as claimed in claim 22, wherein the pressure is exerted with elastic force.

25. A device according to claim 22, wherein the pressure is exerted by the fixing device with one of a positive and negative pressure of a gas or gas mixture.

26. A device according to claim 25, wherein air is provided as a gas mixture.

27. A device according to claim 25, further comprising:
a compressor connected to said fixing device to generate the one of positive and negative pressure, said compressor being connected to provided the one of negative and positive pressure to separate page-shaped recording media from a stack.

28. A device according to claim 25, whereby a control is provided with which a strength of the one of positive and negative pressure is adjusted dependent on a weight of the pages.

29. A device according to claim 20, further comprising:
a page acceptance region in which all pages are offset stacked;
two stoppers bordering said page acceptance region and disposed at right angles to one another, said two stoppers including a front wall lying on a common axis and a side wall arranged at a right angle thereto;
lateral displacement of pages ensuing along the common axis;
a first paddlewheel is provided in a region of a first stopper of said two stoppers, said first paddlewheel being operable to advance first pages with their corners into the right angle of the first stopper, said first paddlewheel providing offset stacking of the first pages of the first job;
a second paddlewheel is provided is in a region of a second stopper of said two stoppers, said second paddlewheel being operable to advance second pages with their corners into the right angle of the second stopper, said second paddlewheel providing offset stacking of the second pages of the second job, and
said fixing device is disposed in a region of a stopper.

30. A device according to claim 29, wherein at least one of said two paddlewheels and said fixing device are mounted so as to be movable along an axle for a format change-over of the pages.

31. A device according to claim 30, wherein said at least one of said two paddlewheels and said fixing device are mechanically and rigidly connected with one another.

32. A printer or copy device, comprising:
a recording media transport system to transport pages of recording media for print jobs, said transport system having an input and an output;
a printing apparatus mounted to print recording media as it is transported by said transport system, said printing apparatus printing the recording media in print jobs;
a page offset stacking apparatus at said output and operable to offset stack the pages of a successive second print job over pages of a preceding first print job so that said pages of said second job and said first job are spatially offset with respect to one another; and
a fixing device with which an uppermost page of the first page stack is mechanically fixed to the first page stack.
